(19) United States
(12) Patent Application Publication
(10) Pub. No.: US 2001/0036553 A1
(43) Pub. Date: Nov. 1, 2001

(54) Potical film laminate

(76) Inventors: Masayuki Satake, Osaka (JP); Yasushi Takahashi, Osaka (JP); Yuji Saiki, Osaka (JP); Tominari Araki, Osaka (JP); Tetsuo Kaneko, Osaka (JP)

Correspondence Address: SUGHRUE, MION, ZINN, MACPEAK & SEAS, PLLC, 2100 Pennsylvania Avenue, N.W., Washington, DC, 20037, US

(21) Appl. No.: 09/816,342

(22) Filed: Mar. 26, 2001

(30) Foreign Application Priority Data
Mar. 27, 2000 (JP) P. 2000-86174

(51) Int. Cl. B32B 27/36; B32B 27/40; G02B 5/22

(52) U.S. Cl. 428/412; 428/423.1; 359/890

(57) ABSTRACT

An optical film laminate which is less apt to have adhesive deficiencies or cause adhesive soils. The optical film laminate comprises an optical film layer 1 and a pressure-sensitive adhesive layer 3, wherein non-tacky powders 5 are adhered to edge surfaces of the pressure-sensitive adhesive layer.

### FIELD OF THE INVENTION

The present invention relates to an optical film laminate for use in liquid crystal displays, touch panels, and the like. More particularly, the invention relates to an optical film laminate suitable for transportation and handling.

### DESCRIPTION OF THE RELATED ART

Various optical films including polarizing films and wavelength films are used in liquid crystal displays and touch panels. These optical films are used not as single films but as a laminate comprising two or more kinds of optical films united through pressure-sensitive adhesive layers, for the purpose of controlling or regulating the direction of vibration of light or retardation. These pressure-sensitive adhesive layers are generally formed beforehand by coating on either or both sides of an optical film to be laminated because separately forming a pressure-sensitive adhesive layer on optical films by coating at the time of laminating results in a low production efficiency.

Such an optical film on which a pressure-sensitive adhesive layer has been formed beforehand has a strippable release paper on the surface of the pressure-sensitive adhesive layer so as to prevent the pressure-sensitive adhesive layer from adhering to unintended parts before being laminated to another optical film or to a glass plate serving as a transparent substrate for a display. There also are cases where such an optical film has been laminated to several other optical films through pressure-sensitive adhesive layers.

In any event, however, the edge surfaces of those pressure-sensitive adhesive layers have been in an exposed state. There have hence been cases where edge surfaces of the pressure-sensitive adhesive layers, during transportation, handling, etc., come into contact with a transporting machine or the body of a worker and, as a result, the pressure-sensitive adhesive partly separates from the edge of the optical film (hereinafter referred to as “lack of adhesive”) and cases where the pressure-sensitive adhesive thus separated from the optical film soils the surface of the optical film (hereinafter referred to as “adhesive soil”). Lack of adhesive not only inhibits the optical film from being bonded to a panel without fail but also causes display failures because the adhesive-lack areas, serving as an air layer, differ from the other areas in the refractive index of light and the direction of vibration of light. Adhesive soils likewise cause display failures.

### SUMMARY OF THE INVENTION

An object of the invention is to provide an optical film laminate which is less apt to have lack of adhesive or cause adhesive soils.

The optical film laminate according to the invention comprises an optical film layer and a pressure-sensitive adhesive layer, wherein non-tacky powders having a specific gravity d of 4.0 or lower are adhered to edge surfaces of the pressure-sensitive adhesive layer.

### BRIEF DESCRIPTION OF THE DRAWINGS

FIG. 1 is a plane view showing one embodiment of the optical film laminate of the invention.

FIG. 2 is a sectional view showing a thickness direction section of the embodiment of the optical film laminate.

### DESCRIPTION OF REFERENCE NUMERALS

1 Optical film

3 Pressure-sensitive adhesive layer

5 Powder

### DETAILED DESCRIPTION OF THE INVENTION

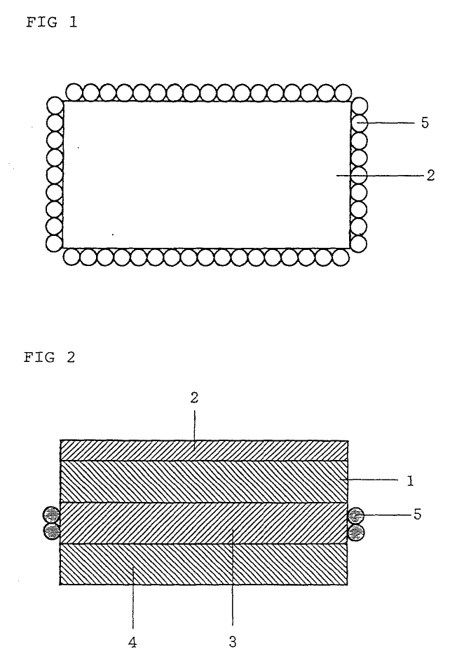

For eliminating the problems described above, the invention provides an optical film laminate which comprises an optical film layer 1 and a pressure-sensitive adhesive layer 2, wherein non-tacky powders 5, 5 . . . 5 are adhered to edge surfaces of the pressure-sensitive adhesive layer 2, as shown in the plane view of FIG. 1 and the thickness direction sectional view of FIG. 2. The laminate shown in the drawings has a protective film 2 superposed on the optical film layer 1 on the side opposite the pressure-sensitive adhesive layer 2, and further has a release paper 4 superposed on the other side of the pressure-sensitive adhesive layer 2. Although another optical film may be superposed in place of the release paper 4, these members are not indispensable to the invention. Further, although the embodiment shown in the drawings has only one optical film layer and only one pressure-sensitive adhesive layer, these layers may be superposed in a large number.

In the invention, the non-tacky powders are adhered to the edge surfaces of the pressure-sensitive adhesive layer, thereby preventing the edge surfaces from directly contacting any external object. Even upon contact with an external object, the powders do not separate from the pressure-sensitive adhesive layer because the powders are non-tacky. For adhering powders to the edge surfaces of the pressure-sensitive adhesive layer, the following method may be used. Two or more optical films each having a pressure-sensitive adhesive layer are superposed, and powders are applied by, e.g., brushing or spraying with an air gun while the superposed films are maintained being pressed against each other from the uppermost and lowermost sides or from the left and right sides. The excess powders are blown off by air blowing or another means. Thus, powders can be evenly adhered to the edge surfaces of each pressure-sensitive adhesive layer substantially in the minimum amount. The powders preferably have a particle diameter smaller than the thickness of the pressure-sensitive adhesive layer.

The optical film is not particularly limited, and at least one member selected from a polarizing film, a wavelength film, an elliptically polarizing film, and an optical compensating film can be used.

When the powders have a specific gravity d of 4.0 or lower, high efficiency is attained in the application thereof by spraying with air and in the removal of excess powders by air blowing.

The powders need not be adhered in a large amount such that the edge surfaces of the pressure-sensitive adhesive layer are wholly covered therewith. As long as the areas covered with the powders account for at least 5% of the edge surfaces of the pressure-sensitive adhesive layer, the effects of the invention are produced sufficiently. The percentage of covering is preferably 5 to 95%, more preferably 5 to 80%, most preferably 15 to 75%.

Some liquid crystal display panels are required to have a heat resistance of 100° C. or higher as in on-vehicle applications. If the particles in the optical film laminate for use in such an application have a low melting point, there are cases where the particles during use soften or melt and drip down to foul unintended parts. Consequently, the melting point of the powders is preferably 100° C. or higher.

There are cases where the whole optical film laminate is rinsed with water in a process for producing the same. If the powders dissolve in this rinsing step, not only the function of edge surface protection is lost but also the material of the powders which has been dissolved may foul unintended parts upon drying. Furthermore, in the case where the optical film is a polarizing film, if the powders absorb water, the absorbed water disadvantageously swells the organic polymer serving as a polarizer, such as poly(vinyl alcohol), to thereby modify the optical properties. Consequently, the powders preferably have a water absorption of 5% or lower.

Examples of the powders include zinc oxide, zinc stearate, aluminum stearate, calcium stearate, and rosin. Such particulate materials may be used alone or in combination of two or more thereof. Preferred of those are the metal salts of stearic acid. This is because the metal stearates satisfy most of the requirements described above.

The invention will be explained below in more detail by reference to the following Examples, but the invention should not be construed as being limited thereto.

### EXAMPLE 1

A hundred polarizing films eleven inches square each bearing a pressure-sensitive adhesive layer were prepared by punching and stacked up. The stacked films were held with a vise type jig from the upper and lower sides thereof, and a powder of zinc stearate (d=1.2) was applied to the edge surfaces of the stack with a brush. Excess zinc stearate particles were then removed by air blowing to produce optical film laminate No. 1.

Optical film laminate No. 2 and No. 3 were produced in the same manner as above, except that each of aluminum stearate (d=1.0) and zinc oxide (d=5.4) was used in place of the zinc stearate.

The laminates obtained were evaluated for edge tackiness, adhesive deficiency, adhesive soil, and suitability for air blowing, and the results obtained are shown in Table 1. The methods of evaluation used are as follows.

Lack of Adhesive, Adhesive Soil

A hundred laminates (total number of polarizing films, 10,000) were separately packaged and transported with a truck, etc. Thereafter, the packages were opened and the worker visually examined the laminates and evaluated the laminates based on a comparison with the laminates before packaging. The laminates in which the pressure-sensitive adhesive had been partly lost were judged to have lack of adhesive, while those in which the surface of the polarizing film had been soiled by the pressure-sensitive adhesive were judged to have an adhesive soil.

Suitability for Air Blowing

After the powder application, the time required for removing excess particles by air blowing was measured. The laminates in which that time was shorter than 1 minute were judged satisfactory (◯), while those in which that time was 1 minute or longer were judged unsatisfactory (×).

TABLE 1

| | No. 1 | No. 2 | No. 3 |
|---|---|---|---|
| Edge tackiness | Non-tacky | Non-tacky | Non-tacky |
| Number of laminates having | 0/100 | 0/100 | 0/100 |
| Lack of adhesive | | | |
| Number of laminates having | 0/100 | 0/100 | 0/100 |
| Adhesive soil | | | |
| Suitability for air blowing | ◯ | ◯ | X |

No. 3: Comparison

### EXAMPLE 2

The zinc stearate and aluminum stearate used in laminate Nos. 1 and 2 in Example 1 had melting points of 115° C. and 150° C., respectively. The same procedure as in Example 1 was conducted, except that rosin (melting point=90° C.) was used in place of the zinc stearate. Thus, laminate No. 4 was produced.

The laminates obtained were evaluated for edge tackiness, lack of adhesive, and adhesive soil in the same manners as in Example 1 and further evaluated for heat resistance. The results obtained are shown in Table 2. Heat resistance was evaluated by the following method.

Heat Resistance

Laminates (each having a hundred polarizing films) were separately applied to glass plates and placed in a 100° C. heating chamber for 250 hours. Thereafter, the laminates were examined. The laminates which had not been fouled were judged satisfactory (◯), while those which had been fouled by a melt of the particles were judged unsatisfactory (×).

TABLE 2

| | No. 1 | No. 2 | No. 4 |
|---|---|---|---|
| Edge tackiness | Non-tacky | Non-tacky | Non-tacky |
| Number of laminates having | 0/100 | 0/100 | 0/100 |
| adhesive deficiency | | | |
| Number of laminates having | 0/100 | 0/100 | 0/100 |
| adhesive soil | | | |
| Heat resistance | ◯ | ◯ | X |

No. 4: Comparison

### EXAMPLE 3

The zinc stearate used in laminate No. 1 in Example 1 had a water absorption of 1.0%. The same procedure as in Example 1 was conducted, except that each of calcium stearate (water absorption=3.0%) and potassium carbonate (water absorption=30%) was used in place of the zinc stearate. Thus, laminate No. 5 and laminate No. 6 were produced respectively.

The laminates obtained were evaluated for edge tackiness, lack of adhesive, and adhesive soil in the same manners as in Example 1 and further evaluated for cleaning resistance. The results obtained are shown in Table 3. Cleaning resistance was evaluated by the following method.

Cleaning Resistance

A hundred laminates (total number of polarizing films, 10,000) were separately applied to glass plates, subsequently immersed in water for 3 minutes, and then dried. Thereafter, the laminates were visually examined to count the number of laminates which had been fouled. The laminates none of which had been fouled were judged satisfactory (◯), those of which less than five had been fouled were judged fair (Δ), and those of which five or more had been fouled were judged unsatisfactory (×).

TABLE 3

| | No. 1 | No. 5 | No. 6 |
|---|---|---|---|
| Edge tackiness | Non-tacky | Non-tacky | Non-tacky |
| Number of laminates having | 0/100 | 0/100 | 0/100 |
| adhesive deficiency | | | |
| Number of laminates having | 0/100 | 0/100 | 0/100 |
| adhesive soil | | | |
| Cleaning resistance | ◯ | Δ | X |

No. 6: Comparison

### EXAMPLE 4

Laminate No. 1 obtained in Example 1 was examined with a microscope in a manner such that a part of an edge surface of the laminate was located just under the objective of the microscope to determine the percentage of covering using the equation (percentage of covering)=[(area occupied by the particles)/(total area of the pressure-sensitive adhesive layer)]×100. The percentage of covering of laminate No. 1 obtained in Example 1 was 10%. Laminate Nos. 7 and 8 were produced under the same conditions as for laminate No. 1, except that the percentage of covering was changed to 30% and 2%, respectively, by changing the time for air blowing. For the purpose of comparison, laminate No. 9 was produced under the same conditions as for laminated No. 1, except that no particles were adhered.

The laminates obtained were evaluated for edge tackiness, lack of adhesive, and adhesive soil in the same manner as in Example 1. The results obtained are shown in Table 4.

TABLE 4

| | No. 1 | No. 7 | No. 8 | No. 9 |
|---|---|---|---|---|
| Edge tackiness | Non-tacky | Non-tacky | Slightly | Tacky |
| | | | tacky | |
| Number of laminates | 0/100 | 0/100 | 2/100 | 5/100 |
| having adhesive | | | | |
| deficiency | | | | |
| Number of laminates | 0/100 | 0/100 | 1/100 | 4/100 |
| having adhesive soil | | | | |

As described above, the optical film laminate of the invention is less apt to have adhesive deficiencies or cause adhesive soils and can hence be easily transported and handled. Consequently, the laminate can be produced in a high yield.

What is claimed is:

1. An optical film laminate comprising an optical film layer and a pressure-sensitive adhesive layer, wherein non-tacky powders having a specific gravity d of 4.0 or lower are adhered to edge surfaces of the pressure-sensitive adhesive layer.

2. The optical film laminate of claim 1, wherein the optical film comprises at least one member selected from the group consisting of a polarizing film, a wavelength film, an elliptically polarizing film, and an optical compensating film.

3. The optical film laminate of claim 1, wherein areas of the edge surfaces of the pressure-sensitive adhesive layer which are covered with the powders account for at least 5% of the edge surfaces.

4. The optical film laminate of claim 1, wherein the powders have a melting point of 100° C. or higher.

5. The optical film laminate of claim 1, wherein the powders have a water absorption of 5% or lower.

6. The optical film laminate of claim 1, wherein the powders are particles of a metal salt of stearic acid.
